(19) United States
(12) Patent Application Publication
(10) Pub. No.: US 2005/0198442 A1
(43) Pub. Date: Sep. 8, 2005

(54) Conditionally accessible cache memory

(76) Inventor: Alberto Rodrigo Mandler, Rehovot (IL)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/791,083

(22) Filed: Mar. 2, 2004

(51) Int. Cl. G06F 12/00

(52) U.S. Cl. 711/145; 711/133

(57) ABSTRACT

A cache memory has a conditional access mechanism, operated by a locking condition. The conditional access mechanism uses the locking condition to implement conditional accessing of the cache memory.

### FIELD AND BACKGROUND OF THE INVENTION

The present embodiments relate to a cache memory having a locking condition, and, more particularly, to accessing a cache memory conditional upon the fulfillment of a locking condition.

Memory caching is a widespread technique used to improve data access speed in computers and other digital systems. Cache memories are small, fast memories holding recently accessed data and instructions. Caching relies on a property of memory access known as temporal locality. Temporal locality states that information recently accessed from memory is likely to be accessed again soon. When an item stored in main memory is required, the processor first checks the cache to determine if the required data or instruction is there. If so, the data is loaded directly from the cache instead of from the slower main memory. Due to temporal locality, a relatively small cache memory can significantly speed up memory accesses for most programs.

FIG. 1 illustrates a prior art processing system 100 in which the system memory 110 is composed of both a fast cache memory 120 and a slower main memory 130. When processor 140 accesses data from the system memory 110, the processor first checks the cache memory 120. Only if the memory item is not found in the cache memory 120 is the data retrieved from the main memory 130. The data retrieved from main memory 130 is then stored in cache memory 120, for later accesses. Data which was previously stored in the cache memory 120 can be accessed quickly, without accessing the slow main memory 130.

There are currently three prevalent mapping strategies for cache memories: the direct mapped cache, the fully associative cache, and the n-way set associative cache. In the direct mapped cache, a portion of the main memory address of the data, known as the index, completely determines the location in which the data is cached. The remaining portion of the address, known as the tag, is stored in the cache along with the data. To check if required data is stored in the cached memory, the processor compares the main memory address of the required data to the main memory address of the cached data. As the skilled person will appreciate, the main memory address of the cached data is generally determined from the tag stored in the location required by the index of the required data. If a correspondence is found, a cache hit is obtained from the cache memory, the data is retrieved from the cache memory, and a main memory access is prevented. Otherwise a cache miss is obtained, and the data is accessed from the main memory. The drawback of the direct mapped cache is that the data replacement rate in the cache is generally high, thus reducing the effectiveness of the cache.

The opposite policy is implemented by the fully associative cache, in which cached information can be stored in any row. The fully associative cache alleviates the problem of contention for cache locations, since data need only be replaced when the whole cache is full. In the fully associative cache, however, when the processor checks the cache memory for required data, every row of the cache must be checked against the address of the data. To minimize the time required for this operation, all rows are checked in parallel, requiring a significant amount of extra hardware.

The n-way set associative cache memory is a compromise between the direct mapped cache and the fully associative cache. Like the direct mapped cache, in a set-associative cache the index of the address is used to select a row of the cache memory. However, in the n-way set associative cache each row contains n separate ways, each one of which can store the tag, data, and any other required indicators. In an n-way set associative cache, the main memory address of the required data is checked against the address associated with the data in each of the n ways of the selected row, to determine if the data is cached. The n-way set associative cache reduces the data replacement rate (as compared to the direct mapped cache) and requires only a moderate increase in hardware.

Cache memories must maintain cache coherency, to ensure that both the cache memory and the main memory are kept current when changes are made to data values that are stored in the cache memory. Cache memories commonly use one of two methods, write-through and copy-back, to ensure that the data in the system memory is current and that the processor always operates upon the most recent value. The write-through method updates the main memory whenever data is written to the cache memory. With the write-through method, the main memory always contains the most up to date data values, but places a significant load on the data buses, since every data update to the cache memory requires updating the main memory as well. The copy-back method, on the other hand, updates the main memory only when modified data in the cache memory is replaced, using an indicator, known as the dirty bit. Copy-back caching saves the system from performing many unnecessary write cycles to the main memory, which can lead to noticeably faster execution.

Cached data can be modified by invalidating, updating, or replacing the data. Cache memory data may be invalidated during startup, or to clear the cache memory for new data. Data cached in a given way is invalidated by clearing the way's validity bit to indicate that the data stored in the way is not valid data. Storing data in a way containing invalid data is relatively quick and simple. The data is inserted into the data field, and the way's validity bit is set.

Data cached in a cache memory section is updated when new data for the main memory location allocated to the section is written to the cache. During a write operation to a specified main memory location, the cache memory is first checked for a cache hit indicating that a cache memory way is already allocated to the specified location. If a cache hit is obtained, the data value in the allocated way is updated to the new data value. If a copy-back coherency method is used, the section's dirty bit is set. Updating section data does not cause the cache memory section to be reallocated to a different main memory location.

Data cached in a cache memory section may be replaced by data from a different main memory location during both read and write memory accesses. When a cache miss occurs during a write transaction, a way is allocated to hold the required main memory data, and the data is cached within the allocated way. If no ways are free, a way is selected for replacement, and valid data in the selected way may be replaced. When a cache miss occurs during a read transaction, the required data is read from the main memory and then cached in a newly allocated way, possibly replacing valid data.

In certain cases, the cache memory contains data which it is preferred to maintain in the cache, and not invalidate or replace by different main memory data. The cache memory may contain a vital section of code, which is accessed repeatedly. Replacing the vital data by more recently accessed, but less needed, data may result in significantly reduced system performance.

A current strategy for preventing replacement of critical cached data is to lock the cache memory sections containing the critical data. Locked data can be updated but cannot be replaced. A lock bit is commonly provided for every cache memory way or group of ways (i.e. a cache memory index). When the lock bit of a given cache memory way is set, data cached in the way is locked, and is not replaced until the data cached in the way is unlocked (by clearing the way's lock bit) or invalidated (by clearing the way's validity bit).

The cache hit/miss indication is used to distinguish between cache memory write operations which update cached data with new data for the currently allocated main memory location, and those that replace cached data with data of a different main memory location. When a main write access is performed to a given main memory location, the cache memory is first checked for a cache hit to determine if a cache memory way is already allocated to the main memory location. In the case of a cache hit, performing the operation may update cached data but will not cause data replacement. However if a cache miss occurs, modifying data in a selected cache memory section may cause data replacement, if the selected way already contains valid data.

The state of a cache memory section's lock bit affects only main memory accesses which require writing to the cache memory, and which cause a cache memory miss. If the cache miss is caused by a main memory write operation, the new data is written directly to the main memory. If the cache miss is caused by a processor read operation, the required data is provided to the processor directly from the main memory, and is not stored in the cache memory.

A locking operation is generally performed for blocks of main memory addresses. In an associative cache memory, cached data from consecutive main memory addresses are generally not stored in consecutive cache memory ways. The lock bits are therefore dispersed throughout the cache memory. When the locked data is no longer required, the ways must either be unlocked or invalidated to allow replacement by newer data. Clearing the dispersed lock bits is a cumbersome operation, since the ways to be unlocked must be located within the cache memory. Commonly, the ways are freed for replacement by invalidating the entire cache memory. Invalidating the entire cache memory may take several clock cycles, since the memory access width limits how many cache memory indices can be accessed in a single cycle. Another problem is that all the currently cached data is lost, which may cause later delays when the data is reloaded into the cache memory. A current method for maintaining cache coherency for a locked way is to invalidate the data cached in the way whenever the associated main memory data is changed. If the invalidated way contained vital data, the system stalls while the data is reloaded into the cache.

Alternate techniques for preventing replacement of cached data are to disable the cache, or to define processing instructions which bypass the cache. Both these techniques ensure that currently cached data is retained in the cache memory, but can lead to cache coherency problems when changes made to main memory data are not made to the corresponding cached data.

There is currently no technique for preserving vital data within a cache memory without modifying the cache memory control array, while maintaining cache coherency. The cached data may be unlocked, in which case it may be replaced by less important data. Alternately, it may be locked, which requires later, potentially time-consuming cache memory accesses to clear lock or validity bits.

There is thus a widely recognized need for, and it would be highly advantageous to have, a cache memory devoid of the above limitations.

### SUMMARY OF THE INVENTION

According to a first aspect of the present invention there is provided a cache memory with a conditional access mechanism, which is operated by a locking condition. The conditional access mechanism uses the locking condition to implement conditional accessing of the cache memory.

According to a second aspect of the present invention there is provided a memory system, consisting of a main memory and a cache memory. The cache memory serves for caching main memory data, and has a conditional access mechanism configurable with a locking condition. The conditional access mechanism uses the locking condition to implement conditional accessing of the cache memory.

According to a third aspect of the present invention there is provided a processing system, consisting of a processor, a main memory, and a cache memory. The cache memory serves for caching main memory data, and has a conditional access mechanism configurable with a locking condition. The conditional access mechanism uses the locking condition to implement conditional accessing of the cache memory. The processor accesses the main memory via the cache memory.

According to a fourth aspect of the present invention there is provided a method for conditionally locking a cache memory. The cache memory has multiple sections for caching the data of an associated main memory. The method consists of the steps of: specifying a locking condition, and performing conditional accesses to the cache memory in accordance with a main memory access command and the fulfillment of said locking condition.

The present invention successfully addresses the shortcomings of the presently known configurations by providing a cache memory with a locking condition.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a prior art processing system having a system memory composed of both a fast cache memory and a slower main memory.

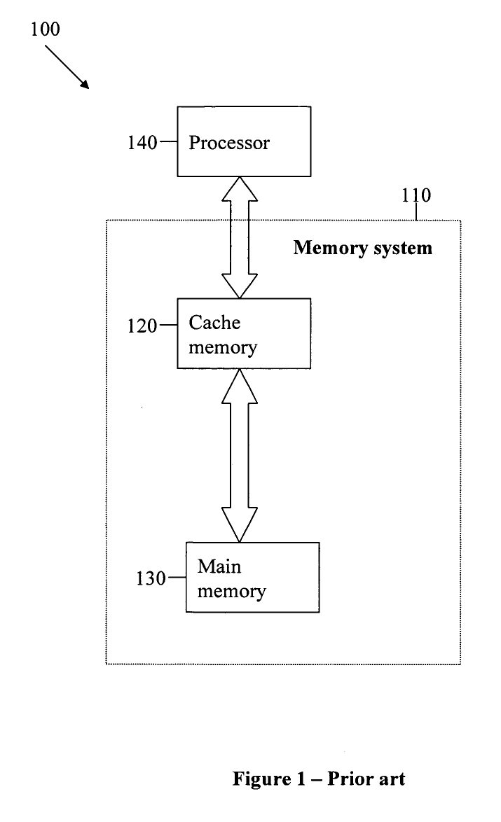

FIG. 2 is a simplified block diagram of a cache memory with a conditional access mechanism, according to a preferred embodiment of the present invention.

FIG. 3 is a simplified block diagram of cache memory with a conditional access mechanism, according to a preferred embodiment of the present invention.

FIG. 4 is a simplified flowchart of a method for conditionally locking specified sections of a cache memory, according to a preferred embodiment of the present invention.

FIG. 5 is a simplified flowchart of a method for performing a conditional access, according to a preferred embodiment of the present invention.

FIG. 6 is a simplified flowchart of a method for accessing a cache memory conditional upon a main memory address, according to a preferred embodiment of the present invention.

FIG. 7 is a simplified flowchart of a method for accessing a cache memory conditional upon a processor accessing the main memory, according to a preferred embodiment of the present invention.

FIG. 8 is a simplified flowchart of a method for accessing a cache memory access with conditional locking, according to a preferred embodiment of the present invention.

### DESCRIPTION OF THE PREFERRED EMBODIMENTS

The present embodiments are of a cache memory having a locking condition, and a conditional access mechanism which performs conditional accessing of cached data. Specifically, the present embodiments can be used to prevent replacement of cached data while maintaining cache coherency, without accessing the lock bits of the cache memory control array.

The principles and operation of a conditionally accessible cache memory according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

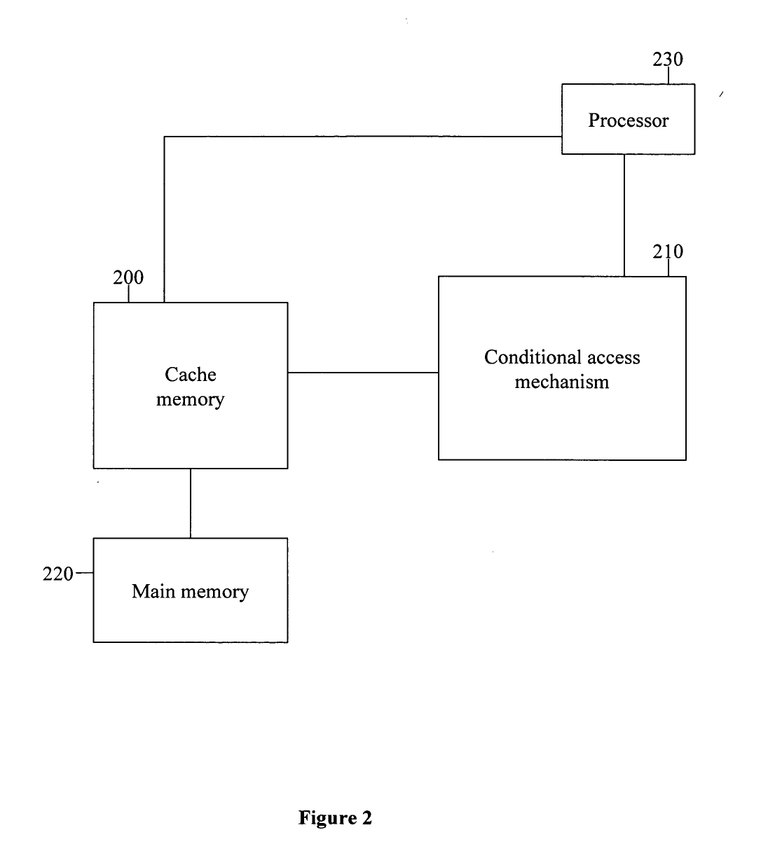

Reference is now made to FIG. 2, which is a simplified block diagram of a cache memory with a conditional access mechanism, according to a preferred embodiment of the present invention. Cache memory 200 is integrated with a conditional access mechanism 210, which performs conditional cache accesses based on a Boolean locking condition. Conditional access mechanism 210 is associated with main memory 220 and processor 230. Cache memory 200 caches data from main memory 220. Cache memory 200 is composed of multiple sections for storing main memory data. A cache memory section may consist of a single cache memory way, all the ways of each index, a group of indices, and so forth. Processor 230 accesses main memory 220 via cache memory 200.

The present embodiments are directed at an n-way set associative memory, but apply to other cache memory organizations, including direct-mapped and fully associative, without loss of generality.

Conditional access mechanism 210 performs cache memory accesses in accordance with the fulfillment or non-fulfillment of a locking condition. The locking condition is a Boolean condition which is evaluated by conditional access mechanism 210 during memory accesses, to determine whether the data stored in cache memory 200 should be treated as locked or unlocked. If the locking condition is fulfilled, conditional access mechanism 210 performs a conditionally locked access to cache memory 200, otherwise a conditionally unlocked access (denoted herein a standard access) is performed. During a conditionally locked access conditional access mechanism 210 treats all the ways of cache memory 200 as locked, regardless of the state of the cache memory lock bits. During a standard access, the locked/unlocked status of each section is determined by the section's lock bit.

In the preferred embodiment, cache memory 200 and conditional accessor 220 are part of a memory system, which further contains main memory 220. Main memory 220 may be any compatible memory device, such as an embedded dynamic random access memory (EDRAM). In a further preferred embodiment, cache memory 200 and conditional accessor 220 are part of a processing system, which further contains processor 230, and may contain main memory 220.

In the following, a memory access operation which stores or retrieves data from the main memory is referred to as a main memory access. Likewise, a memory access operation which stores or retrieves data from cache memory 200 is referred to as a cache memory access. Cache memory read and write accesses result from main memory access which are performed via cache memory 200. Each cache memory access is therefore associated with a main memory address, that is, the main memory address whose access generated the cache memory access.

As described above, in the prior art, standard cache locking is a mechanism which uses the cache hit/miss indication and the status of the cache memory lock bits to ensure that vital data is not replaced in cache memory 200. Locking the cache affects those main memory accesses which would result in a write access to the cache. New data is written to a locked cache memory only if a cache hit is obtained. Writing data to the cache after a cache hit updates the data in a section already allocated to the associated main memory address, and therefore does not remove any valid data from the cache. If a cache miss is obtained, no way is currently allocated to the main memory address being accessed, so that writing data to cache memory 200 may cause data replacement.

Conditional accessing affects cache write operations only. When performing a cache memory write access, conditional access mechanism 210 checks if the locking condition is fulfilled, and if a cache hit was obtained for the main memory address associated with the cache write operation. If the conditional locking condition is fulfilled, conditional access mechanism 210 treats all sections of cache memory 200 as locked during the current memory access. Conditionally locking a cache memory does not interfere with other memory operations.

As in standard locking of a cache memory section, conditional access mechanism 210 relies on the cache hit/miss indication to determine whether new data can be written to cache memory 200. If a cache hit was obtained, conditional access mechanism 210 writes the new data to cache memory 200. If a cache miss is obtained, conditional access mechanism 210 does not write new data to the cache, but instead either writes the new data directly to main memory 220 (if the cache write access resulted from a main memory write operation) or outputs the main memory data to processor 230 without caching (if the cache write access resulted from a main memory read operation). Conditionally locking a cache memory thus ensures that cached data may be updated but not replaced. As a result, cache coherency is maintained, but there is no need to perform a time consuming invalidation of the cache memory in order to unlock the data.

The locking condition used by conditional access mechanism 210 distinguishes between data that should be retained in the cache, and data that may be replaced. In the preferred embodiment, the locking condition is conditional upon one or more of the following factors:
1) The main memory address being accessed
2) The type of the currently executed memory access command
3) The processor that issued the current memory access command
4) The type of processor that issued the current memory access command
5) The state of a single hardware locking indicator (provided for the entire cache memory).

The locking condition defines the properties of the data which is to be locked in the cache, and distinguishes it from less important data which may be replaced. For example, the locking condition may specify a block of main memory addresses, to ensure that data cached for the specified addresses is retained in cache memory 200. If a main memory access is performed to any other main memory address, the cache is conditionally locked. Thus data from the specified addresses can not be replaced by data from other main memory addresses. However, data cached for other main memory addresses can be updated.

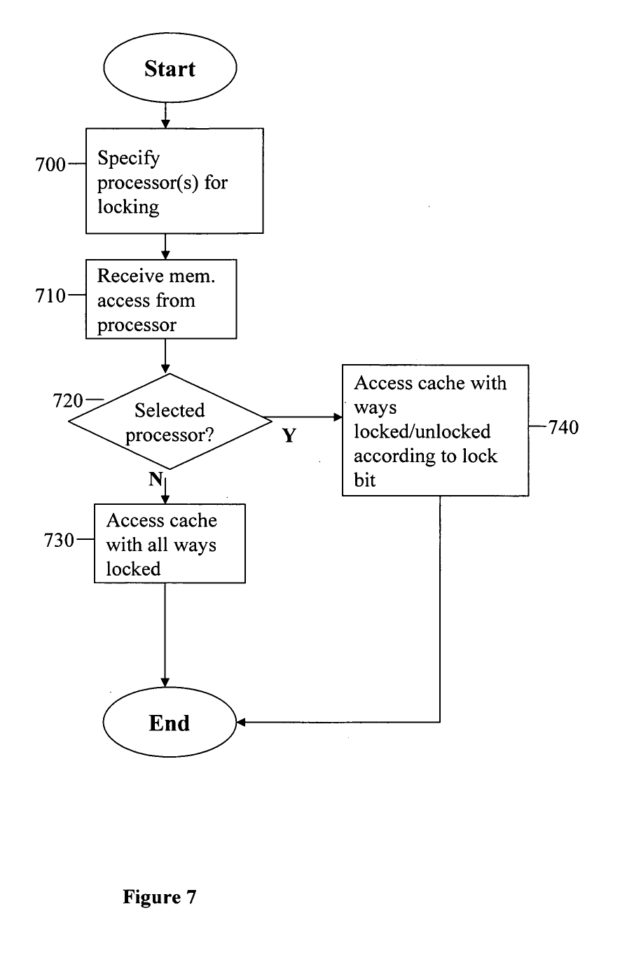

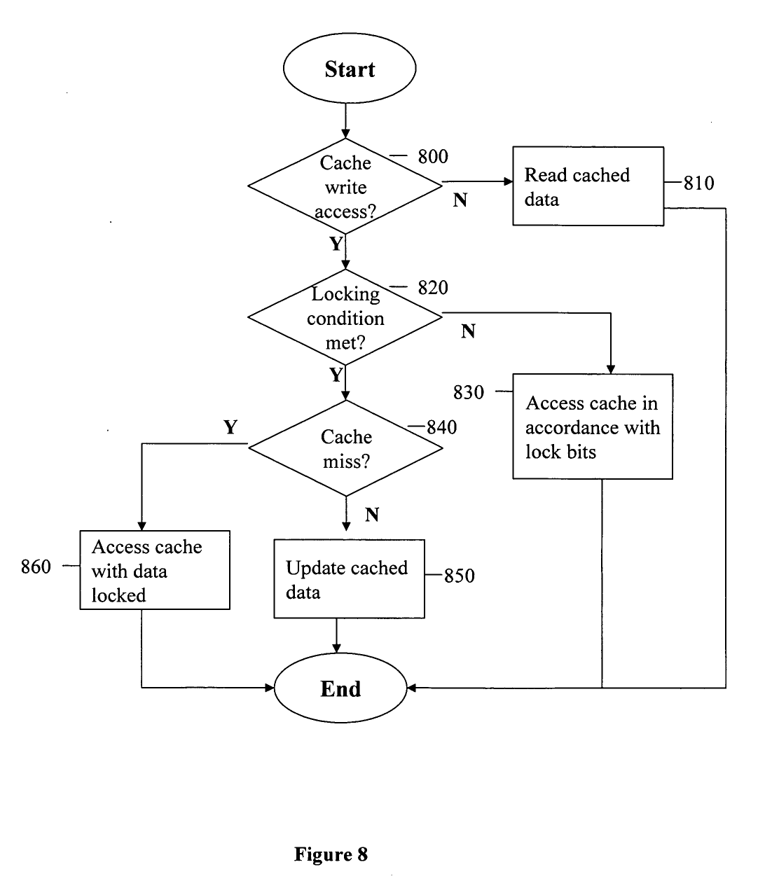

In another example, the memory system is accessible by multiple processors. If one of the processors requires quick data access, the locking condition can specify the processor. Cache memory 200 is conditionally locked during accesses by all other processors, so that data accessed by the specified processor is not replaced by data accessed by other processors. The above examples are described more fully below in FIGS. 7 and 8.

If the locking condition is not fulfilled, a standard access is performed. During a standard access, data in each cache memory section is treated as locked or unlocked in accordance with the section's lock bit. Other embodiments may be possible, such as treating cached data in all cache memory sections as unlocked if the locking condition is not fulfilled.

During execution of a memory access command, conditional access mechanism 210 may access some cache memory sections differently than others. In the above example, the locking condition specifies a range of main memory addresses. If processor 230 performs a main memory access to a block of main memory addresses, conditional access mechanism 210 checks the locking condition for each of the main memory addresses. Conditionally locked accessing is performed only for those cache memory accesses associated with a main memory address outside the range specified by the locking condition. Conditional access unit 220 may check the locking condition a single time or multiple times for each main memory access, depending on the definition of the locking condition.

In the preferred embodiment, conditional locking is turned on and off as needed. Conditional locking can be turned on when it is desired to retain critical data in the cache, and turned off during regular operation. Conditional locking may be turned on and off by setting and clearing a locking indicator, or with a dedicated locking command from a processor accessing the memory system.

A memory access command may include a conditional locking flag, for conditionally locking cache memory 200 during execution of the current command. However including the dedicated flag in the command requires defining a non-standard access command.

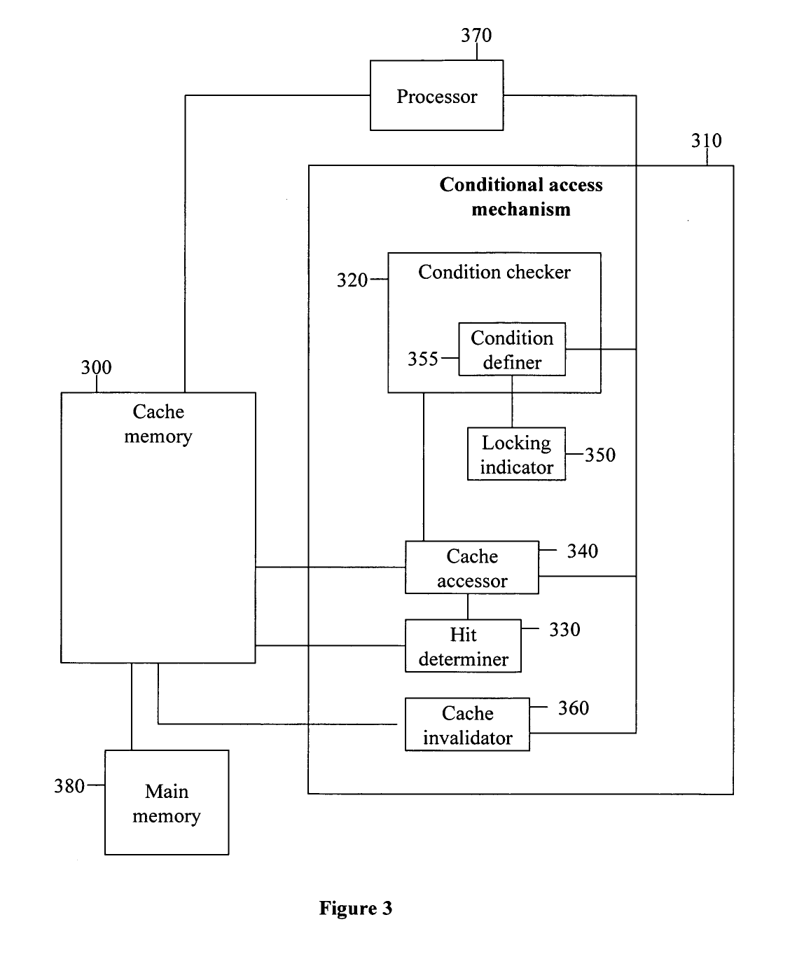

Reference is now made to FIG. 3, which is a simplified block diagram of cache memory with a conditional access mechanism, according to a preferred embodiment of the present invention. In the preferred embodiment, cache memory 300 is integrated with conditional access mechanism 310. Conditional access mechanism 310 consists of condition checker 320, hit determiner 330, and cache accessor 340. Conditional access mechanism 310 may further contain locking indicator 350 and/or cache invalidator 360.

Condition checker 320 determines whether the locking condition is fulfilled. Condition checker 320 checks the locking condition for each cache write access, and provides an indication of fulfillment or non-fulfillment of the locking condition to cache accessor 340. Condition checker 320 may check the locking condition once per memory access command, or for each main memory address accessed, depending upon the definition of the locking condition.

Preferably, condition checker 320 contains condition definer 355, which holds a definition of the current locking command. Condition definer 355 establishes the type of locking condition (for example, that the locking condition is dependant upon the processor currently accessing the memory system). Condition definer 355 may also store the parameters of the currently applied locking command, such as a range of main memory addresses. The type of locking condition and the associated parameters are preferably provided by processor 370. The locking condition may be defined once upon system initialization, or may be redefined during operation. The locking condition may combine multiple types of conditions, such as the processing agent currently accessing the main memory and the main memory address being accessed.

Hit determiner 330 checks whether a cache hit is obtained for the main memory address associated with the current cache memory access, and provides a cache hit/miss indication to cache accessor 340.

Cache accessor 340 performs read and write access operations to cache memory 300. Cache accessor 340 receives main memory access commands from processor 370, which specify one or more main memory addresses to be accessed. The specified main memory addresses are accessed in sequence via cache memory 300. Main memory accesses which result in a cache write access, are performed conditionally by cache accessor 340, in accordance with the locking condition fulfillment indication provided by condition checker 320. Main memory accesses which do not yield a cache write access are performed as standard cache accesses, without regard to the fulfillment status of the locking condition.

Prior to performing a cache write operation, cache accessor 340 receives the fulfillment indication from condition checker 320, and the cache hit/miss indication from hit determiner 330. If the locking condition is fulfilled and a cache hit is obtained, cache accessor 340 writes the data to cache memory 300. If the locking condition is fulfilled and a cache miss is obtained, cache accessor 340 performs the cache write operation with all sections of cache memory 300 locked. As discussed above, this prevents the new data from being written to cache memory 300. As a result, the new data is written directly to main memory 380 or output to a data bus, as described above. If condition checker 320 indicates that the locking condition is not fulfilled, cache accessor 340 performs a standard cache write access in accordance with the cache memory lock bits.

By basing cache write accesses on cache hit/miss indications, cache accessor 340 ensures that cached data is not replaced during conditional locking. When conditional locking is applied, a cache memory section cannot be reallocated to a new main memory location. On the other hand, cache accessor 340 does update data cached in a conditionally locked section with up-to-date data of the currently allocated main memory address.

Preferably, conditional access mechanism 310 contains locking indicator 350, which is checked by condition checker 320 to determine whether locking is turned on or off. Locking indicator 350 is part of the conditional access mechanism, so that checking locking indicator 350 does not require accessing cache memory 300. In the preferred embodiment, a single locking indicator may be provided for the entire cache memory.

Conditionally locking cache memory 300 functions as a coherent cache disable. As discussed above, current methods for disabling a cache memory prevent the replacement of cached data but do not maintain coherency. To perform a coherent cache disable, cache memory 300 is conditionally locked for all memory access transactions. Subsequent main memory accesses do not replace any entry of the cache, until cache memory 300 is unlocked. To prevent all accesses to cache memory 300, the entire cache is first invalidated to release all allocations, and then conditionally locked. Releasing all cache allocations ensures that a cache miss is obtained for every main memory access. Conditional locking then ensures that new data is not written to cache memory 300. All cache read and cache write operations are thus prevented.

Preferably, conditional access mechanism 310 also contains a cache invalidator 360, for invalidating data in specified cache memory sections or the entire cache memory. Cache invalidator 360 sets and clears the valid bits of the specified cache memory sections.

Conditional locking provides a mechanism for performing main memory accesses without replacing important cached data, while maintaining coherency. Critical cached data is conditionally locked, and is not replaced in the cache by subsequent main memory accesses. Thus, for example, main memory data can be updated without losing a sequence of instructions that has been stored in the cache memory.

The following preferred embodiments of a conditional locking method enable locking a cache memory to prevent replacement of critical data, without modifying the lock bits in the cache control array. Conditionally locked data may be updated, but cannot be replaced by data from a different main memory section.

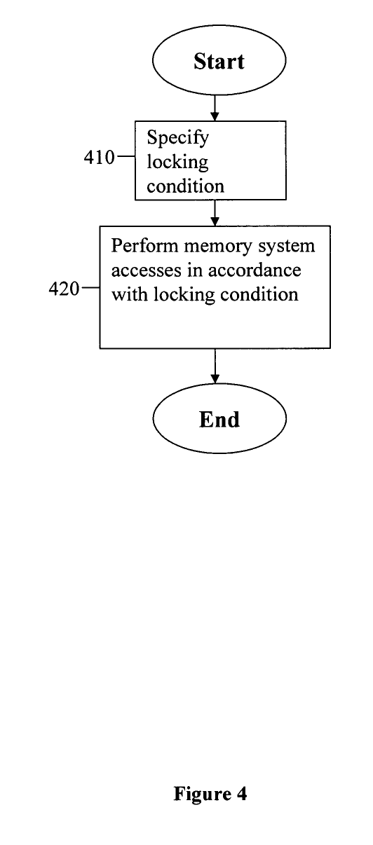

Reference is now made to FIG. 4, which is a simplified flowchart of a method for conditionally locking specified sections of a cache memory, according to a preferred embodiment of the present invention. In step 410, a locking condition is specified for a cache memory. The locking condition may be specified once (generally upon system initialization), or may be modifiable during operation.

In step 420, main memory accesses are performed via the cache memory. As discussed above, cache memory accesses result from main memory accesses performed by a processing agent. If the locking condition is fulfilled, a conditionally locked access is performed; otherwise a standard access is performed. The locking condition may be checked for every cache memory access, or only for cache write accesses. As described above, during a conditionally locked access cached data is updateable by new data of the same main memory address, but is not replaceable by data from a different main memory address. Preferably, the cache hit/miss indication for each main memory address is used during conditionally locked access, to determine whether a cache memory section is currently allocated to the given main memory address. Conditionally locked accessing is described in the following figure.

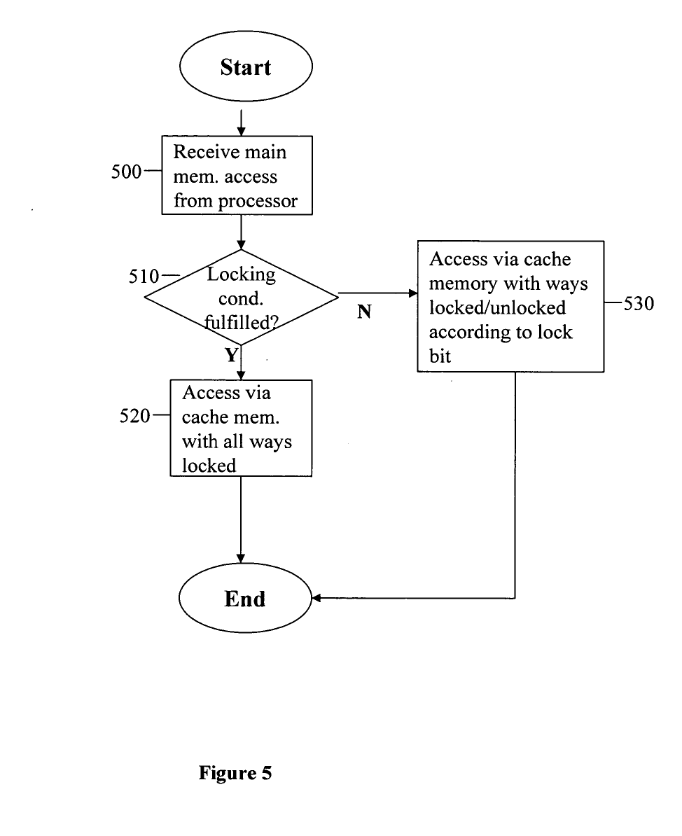

Reference is now made to FIG. 5, which is a simplified flowchart of a method for performing a conditional access, according to a preferred embodiment of the present invention. A conditional access is performed when the locking condition is fulfilled (step 420). In step 500, a memory access command is received from a processor. The memory access command specifies a main memory address to be accessed. In step 510, the locking condition is checked. If the locking condition is fulfilled, in step 520 the main memory access is performed via the cache memory, with all cache memory ways locked. If the locking condition is not fulfilled, in step 530 the main memory access is performed via the cache memory, with each cache memory way locked or unlocked as determined by its lock bit.

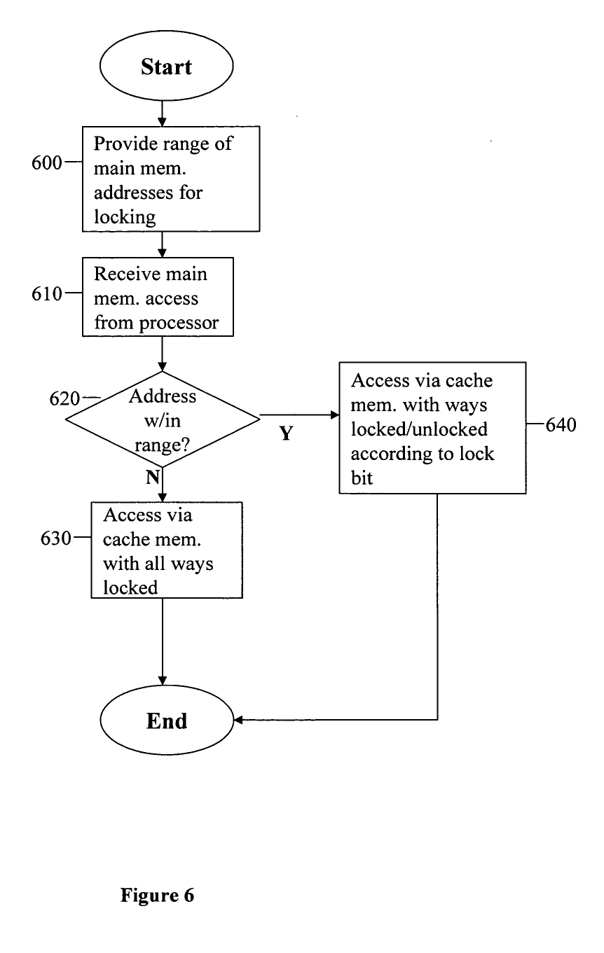

Reference is now made to FIG. 6, which is a simplified flowchart of a method for accessing a cache memory conditional upon a main memory address, according to a preferred embodiment of the present invention. FIG. 6 illustrates an example of conditionally accessing a cache memory, where the decision whether to conditionally lock the cache memory is based on the main memory address currently being accessed by the processor. In step 600, a range of main memory addresses is provided by the processor. Accesses to main memory addresses outside the specified range are conditionally locked accesses, to ensure that cached data from a main memory address within the specified range is not replaced by data from an address outside the range. In step 610, a memory access command is received from a processor, specifying a main memory address to be accessed. In step 620, the main memory address is checked against the range of addresses provided in step 600, to determine whether the address falls within the range. If the currently accessed main memory address is outside the specified range, the locking condition is fulfilled, and the main memory access is performed, in step 630, with all cache memory ways locked. If the main memory address is within the specified range, the locking condition is not fulfilled, and the main memory access is performed in step 640 with each cache memory way locked or unlocked in accordance with the corresponding lock bit.

Reference is now made to FIG. 7, which is a simplified flowchart of a method for accessing a cache memory conditional upon a processor accessing the main memory, according to a preferred embodiment of the present invention. FIG. 7 illustrates an example of conditionally accessing a cache memory, where the decision whether to conditionally lock the cache memory is based on the processor currently accessing the main memory. In step 700, one or more processors are specified by the processor. Accesses by all other processors are conditionally locked accesses, to ensure that cached data required by a specified processor is not replaced by data accessed by another, lower priority, processor. A main memory access command is received from a processor, in step 710. In step 720, it is determined whether the processor issuing the current memory access is one of the processors specified in step 700. If the processor is not one of the specified processors, the locking condition is fulfilled, and the main memory access is performed, in step 730, with all cache memory ways locked. If the processor is one of the specified processors, the locking condition is not fulfilled, and the main memory access is performed in step 740 with each cache memory way locked or unlocked in accordance with its lock bit.

Reference is now made to FIG. 8, which is a simplified flowchart of a method for accessing a cache memory with conditional locking, according to a preferred embodiment of the present invention. The methods of FIGS. 5-7 illustrate how main memory accesses are performed via a conditionally lockable cache memory. FIG. 8 presents a method for performing an access to a cache memory with conditional locking. In step 800, it is determined whether the current cache access is a read access or a write access. If the current cache access is a read access, a standard cache read access is performed in step 810, without consideration of the locking condition.

If the current cache access is a write access, the locking condition is checked, in step 820, to determine whether the locking condition is fulfilled. If the locking condition is not fulfilled, a standard cache write access is performed in step 830, in accordance with the lock bits of the cache memory sections.

If it is determined in step 820 that the locking condition is fulfilled, a conditionally locked write access is performed in steps 840-860. In step 840 it is determined whether the main memory access associated with the current cache write access generated a cache hit or miss. If a cache hit occurred, the cached data is updated in step 850. If a cache miss is obtained, the cache write access is performed in step 860 with all cache memory way treated as locked. The new data is either provided to the processor without being cached or stored directly in the main memory, depending on whether the current main memory access was a read or a write operation.

Preferably the method contains the step of invalidating data in the entire cache memory, or in specified sections of the cache memory.

A cache memory with conditional locking provides a simple mechanism for preventing replacement of cached data while maintaining cache coherency. Conditional accessing is implemented by defining a locking condition, which determines whether a given cache access should be performed with section data treated as locked or unlocked. Determining the locked/unlocked status of cached data on the basis of a locking condition eliminates the need to set and reset the lock bits in the cache memory control array. When a conditionally locked cache memory is later unlocked, no further cache control operations are required. Conditional locking also simplifies coherent cache disabling, to prevent cache accesses during testing or at other critical times.

It is expected that during the life of this patent many relevant cache memories, main memories, memory systems, and methods for caching, updating, and replacing data will be developed and the scope of the term cache memory, main memory, memory system, updating data, replacing data, and caching data is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A cache memory having a conditional access mechanism operated by a locking condition, for conditionally locking said cache memory.

2. A cache memory according to claim 1, wherein said conditional access mechanism comprises:
a condition checker, for determining fulfillment of said locking condition;
a hit determiner, for giving hit and miss indications for data stored in said cache memory; and
a cache accessor, for conditionally implementing a cache memory access in accordance with the fulfillment of said locking condition.

3. A cache memory according to claim 2, wherein said conditional implementing comprises accessing said cache memory with cached data locked if said locking condition is fulfilled.

4. A cache memory according to claim 1, wherein said conditional access mechanism is operable to prevent replacement of data stored in a section of a conditionally locked cache memory.

5. A cache memory according to claim 1, wherein said conditional access mechanism is operable to update data stored in a section of a conditionally locked cache memory.

6. A cache memory according to claim 1, wherein said conditional access mechanism is operable to prevent reallocation of a section of a conditionally locked cache memory.

7. A cache memory according to claim 1, wherein said conditional access mechanism is operable to access a section of a conditionally unlocked cache memory, in accordance with a corresponding lock bit.

8. A cache memory according to claim 1, further comprising a condition definer, for holding a definition of said locking condition.

9. A cache memory according to claim 8, wherein said definition is updateable during operation.

10. A cache memory according to claim 8, wherein said definition comprises a condition type and parameters associated with said type.

11. A cache memory according to claim 1, wherein said locking condition is fulfilled if a currently accessed main memory location comprises a main memory location specified by said locking condition.

12. A cache memory according to claim 1, wherein each main memory access instruction has a type, and wherein said locking condition is fulfilled if a type of said memory access command comprises a command type specified by said locking condition.

13. A cache memory according to claim 1, wherein said cache memory comprises a conditional locking indicator, and wherein said locking condition is fulfilled if said conditional locking indicator is set.

14. A cache memory according to claim 1, wherein said memory access command comprises a conditional locking parameter, for turning on conditional locking during the execution of said command.

15. A cache memory according to claim 1, wherein said accessor is operable to turn conditional accessing on and off in accordance with a predetermined memory access command.

16. A cache memory according to claim 1, wherein said cache memory is for caching data of an associated main memory.

17. A cache memory according to claim 16, wherein said cache memory is further associated with a processor operable to access said associated main memory via said cache memory.

18. A cache memory according to claim 17, wherein said locking condition is fulfilled if said processor comprises a processor specified by said locking condition.

19. A cache memory according to claim 17, wherein a processor has a type, and wherein said locking condition is fulfilled if a type of said processor comprises a processor type specified by said locking condition.

20. A cache memory according to claim 1, wherein said conditional access mechanism further comprises a cache invalidator, for invalidating data in specified cache memory sections.

21. A cache memory according to claim 1, wherein said cache memory comprises an associative memory.

22. A cache memory according to claim 21, wherein a cache memory section comprises a cache memory way.

23. A cache memory according to claim 1, wherein said cache memory comprises an n-way set associative memory.

24. A cache memory according to claim 23, wherein a cache memory section comprises an index of said n-way set associative cache memory.

25. A cache memory according to claim 1, wherein said cache memory comprises a direct-mapped memory.

26. A memory system comprising:
a main memory; and
a cache memory associated with said main memory, for caching data of said main memory, and having a conditional access mechanism configurable with a locking condition, for conditionally locking said cache memory.

27. A memory system according to claim 26, wherein said conditional access mechanism comprises:
a condition checker, for determining fulfillment of said locking condition;
a hit determiner, for giving hit and miss indications for data stored in said cache memory; and
a cache accessor, for conditionally implementing a cache memory access in accordance with the fulfillment of said locking condition.

28. A memory system according to claim 27, wherein said conditional access mechanism is operable to prevent replacement of data stored in a section of a conditionally locked cache memory.

29. A memory system according to claim 27, wherein said conditional access mechanism is operable to update data stored in a section of a conditionally locked cache memory.

30. A memory system according to claim 27, wherein said conditional access mechanism is operable to prevent reallocation of a section of a conditionally locked cache memory.

31. A memory system according to claim 27, wherein said conditional access mechanism is operable to access a section of a conditionally unlocked cache memory in accordance with a corresponding lock bit.

32. A memory system according to claim 26, wherein said locking condition is conditional upon at least one of the following group: a main memory address, a type of a memory access command, a processor, a processor type, and a locking indicator.

33. A memory system according to claim 26, associated with a processor operable to access said main memory via said cache memory.

34. A memory system according to claim 26, wherein said main memory comprises an embedded dynamic random access memory (EDRAM).

35. A processing system comprising:
a main memory;
a cache memory associated with said main memory, for caching data of said main memory, and having a conditional access mechanism configurable with a locking condition, for conditionally locking said cache memory; and
a processor associated with said cache memory, operable to access said main memory via said cache memory.

36. A processing system according to claim 35, wherein said conditional access mechanism comprises:
a condition checker, for determining fulfillment of said locking condition;
a hit determiner, for giving hit and miss indications for data stored in said cache memory; and
a cache accessor, for conditionally implementing a cache memory access in accordance with the fulfillment of said locking condition.

37. A processing system according to claim 36, wherein said conditional access mechanism is operable to prevent replacement of data stored in a section of a conditionally locked cache memory.

38. A processing system according to claim 36, wherein said conditional access mechanism is operable to update data stored in a section of a conditionally locked cache memory.

39. A processing system according to claim 36, wherein said conditional access mechanism is operable to prevent reallocation of a section of a conditionally locked cache memory.

40. A processing system according to claim 36, wherein said conditional access mechanism is operable to access a section of a conditionally unlocked cache memory in accordance with a corresponding lock bit.

41. A processing system according to claim 35, wherein said locking condition is conditional upon at least one of the following group: a main memory address, a type of a main memory access command, a processor, a processor type, and a locking indicator.

42. A method for conditionally locking a cache memory, said cache memory comprising multiple sections for caching the data of an associated main memory, comprising:
specifying a locking condition; and
performing conditional accesses to said cache memory in accordance with a main memory access command and the fulfillment of said locking condition.

43. A method for conditionally locking a cache memory according to claim 42, wherein said cache memory comprises lock bits corresponding to said sections, and wherein said performing comprises:
if said locking condition is fulfilled, accessing said cache memory with cached data locked; and
if said locking condition is not fulfilled, accessing said cache memory in accordance with said lock bits.

44. A method for conditionally locking a cache memory according to claim 42, wherein said locking condition is fulfilled if a currently accessed main memory location comprises a main memory location specified by said locking condition.

45. A method for conditionally locking a cache memory according to claim 42, wherein each main memory access instruction has a type, and wherein said locking condition is fulfilled if a type of said main memory access command comprises a command type specified by said locking condition.

46. A method for conditionally locking a cache memory according to claim 42, wherein said locking condition is fulfilled if a conditional locking indicator is set.

47. A method for conditionally locking a cache memory according to claim 42, wherein said main memory access command comprises a conditional locking parameter, and wherein said locking condition is fulfilled if said conditional locking parameter is set.

48. A method for conditionally locking a cache memory according to claim 42, wherein said main memory access commands originate from an associated processor.

49. A method for conditionally locking a cache memory according to claim 48, wherein said locking condition is fulfilled if said associated processor comprises a processor specified by said locking condition.

50. A method for conditionally locking a cache memory according to claim 48, wherein said locking condition is fulfilled if a type of said associated processor comprises a processor type specified by said locking condition.

51. A method for conditionally locking a cache memory according to claim 42, wherein said conditional accessing comprises preventing reallocation of a section of a conditionally locked cache memory.

52. A method for conditionally locking a cache memory according to claim 42, wherein said cache memory comprises lock bits corresponding to said sections, and wherein said conditional accessing comprises accessing a cache memory section in accordance with a corresponding lock bit, if said locking condition is not fulfilled.

53. A method for conditionally locking a cache memory according to claim 42, wherein said cache memory comprises lock bits corresponding to said sections, and wherein said conditional accessing comprises:
if a current cache access comprises a read access, performing a cache read operation to said cache memory;
if a current cache access comprises a write access, performing:
determining if said locking condition is fulfilled;
if said locking condition is fulfilled:
if a cache hit is obtained for a main memory location associated with said current cache access, performing a cache write operation to update cached data; and
if a cache miss is obtained for said location, performing a cache write operation with cached data locked against replacement; and
if said locking condition is not fulfilled, performing a cache write operation in accordance with said lock bits.

54. A method for conditionally locking a cache memory according to claim 42, further comprising specifying a parameter of said locking condition.

55. A method for conditionally locking a cache memory according to claim 42, further comprising updating said locking condition.

56. A method for conditionally locking a cache memory according to claim 42, further comprising invalidating data cached in said cache memory.
